(19) United States
(12) Patent Application Publication
(10) Pub. No.: US 2018/0211467 A1
(43) Pub. Date: Jul. 26, 2018

(54) MEANS TO CREATE A PHYSICAL AUDIT TRAIL VERIFIABLE BY REMOTE VOTERS IN ELECTRONIC ELECTIONS

(71) Applicant: SMARTMATIC INTERNATIONAL CORPORATION, St. Michael (BB)

(72) Inventors: Paul BABIC, The Hague (NL); Antonio MUGICA, London (GB); Michael SUMMERS, Hungerford (GB)

(73) Assignee: SMARTMATIC INTERNATIONAL CORPORATION, St. Michael (BB)

(21) Appl. No.: 15/412,828

(22) Filed: Jan. 23, 2017

(51) Int. Cl. G07C 13/02

(52) U.S. Cl. CPC G07C 13/02

(57) ABSTRACT

The process of casting a ballot from a remote location over electronic means faces a lot of technological challenges. One key challenge is the fact a purely electronic process leaves no physical or paper audit trail behind for voters to verify their ballots have been recorded properly, and for use in case of a recount. The present invention demonstrates a means to solve this problem by implementing a remote voter-verifiable paper audit trail (R-VVPAT) device.

### BACKGROUND

Technical fields related to the present disclosure include any means or apparatus or system partaking in the act of voting (such as found in the process of electing officials for public office, or other non-government office, etc.), such as electronic voting machines, ballot processing systems, systems to transmit records of ballots by electronic means, systems to vote remotely over electronic means, including the Internet, as well as systems that enable audit or verification of accuracy and integrity of election results.

The prior art in this field includes hundreds of different patent disclosures, academic articles, and other publications looking at the process of voting. Such prior art includes inventions relating to voting devices (such as U.S. Pat. No. 7,422,150B2), to ballot processing devices (such as U.S. Pat. No. 7,077,313B2 and U.S. Pat. No. 7,054,829B2), to voting devices that produce permanent copies of a voter's choices made in it via electronic and/or printed paper means (such as European patent EP 1889229B1), and the process and means of casting a ballot over network transmission media, such as the case of casting a ballot over the Internet (such as U.S. Pat. No. 7,418,401B2).

### SUMMARY

The present disclosure relates specifically to votes that are cast remotely (such as over the Internet). One of the many challenges that election officials face is in demonstrating the validity and veracity of election results when such remote voting means has been used. Some have proposed solutions to this by means of use of digital signatures (PKI) to digitally certify that a ballot is of legitimate origin (such as U.S. Pat. No. 7,549,049B2), while some have also added that there needs to be a way to certify that digitally certified cast ballots have not been subtracted from the electronic ballot box, and to this end have proposed the use of immutable logs (or even the application of block chain technologies) to ensure the safekeeping and preservation of the integrity of the ballot box where remotely cast ballots are stored.

There however remains no way to verify election results without having special knowledge of advanced technologies. In the past, in-person electronic voting systems worked around this by introducing an attached printer that can show the voter for whom he has voted for (or how his ballot has been recorded), namely, a paper trail, which makes it very easy to have voters verify their ballots without special knowledge or skills, and can also serve for later recount purposes. Yet, for people casting ballots remotely over electronic means, no such paper trail has been proposed or implemented.

The present disclosure tackles this need by proposing a means by which paper trails can be generated in a way to both satisfy a voter's need to verify the ballot be submitted over electronic means (e.g., the Internet) has been recorded properly, and the need of electoral officials to be able to demonstrate to stakeholders that the result of an election (including the ballots cast from remote locations) can be recounted to verify the election. The embodiment of this disclosure is called a Remote Voter-Verifiable Paper Audit Trail device (R-VVPAT device), and the paper trail produced by it is called an R-VVPAT.

### DESCRIPTION OF THE DRAWINGS

FIG. 1 shows the main components of the proposed invention in its preferred embodiment.

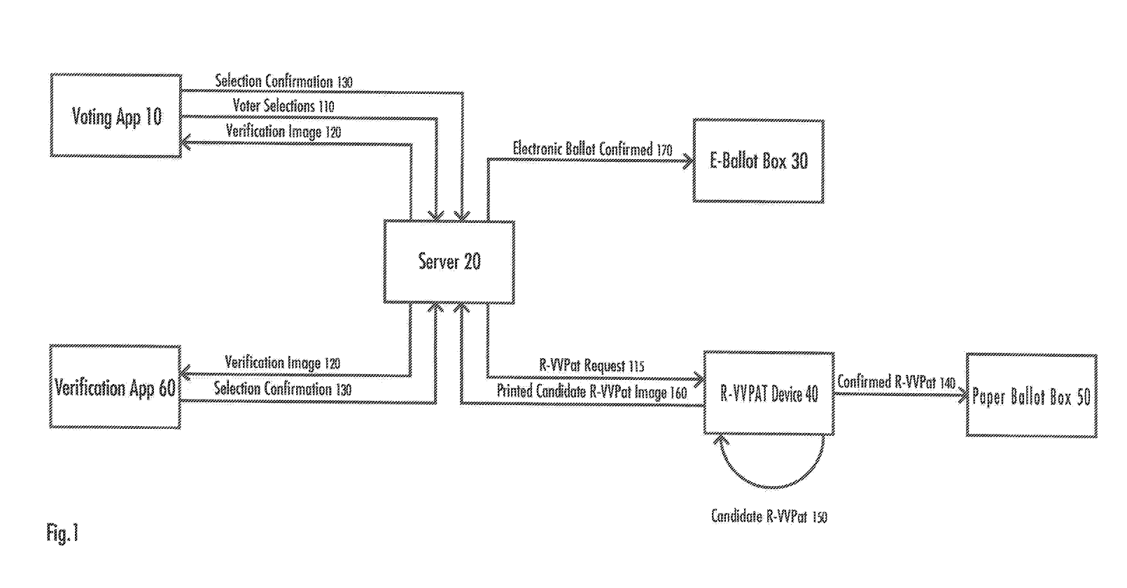

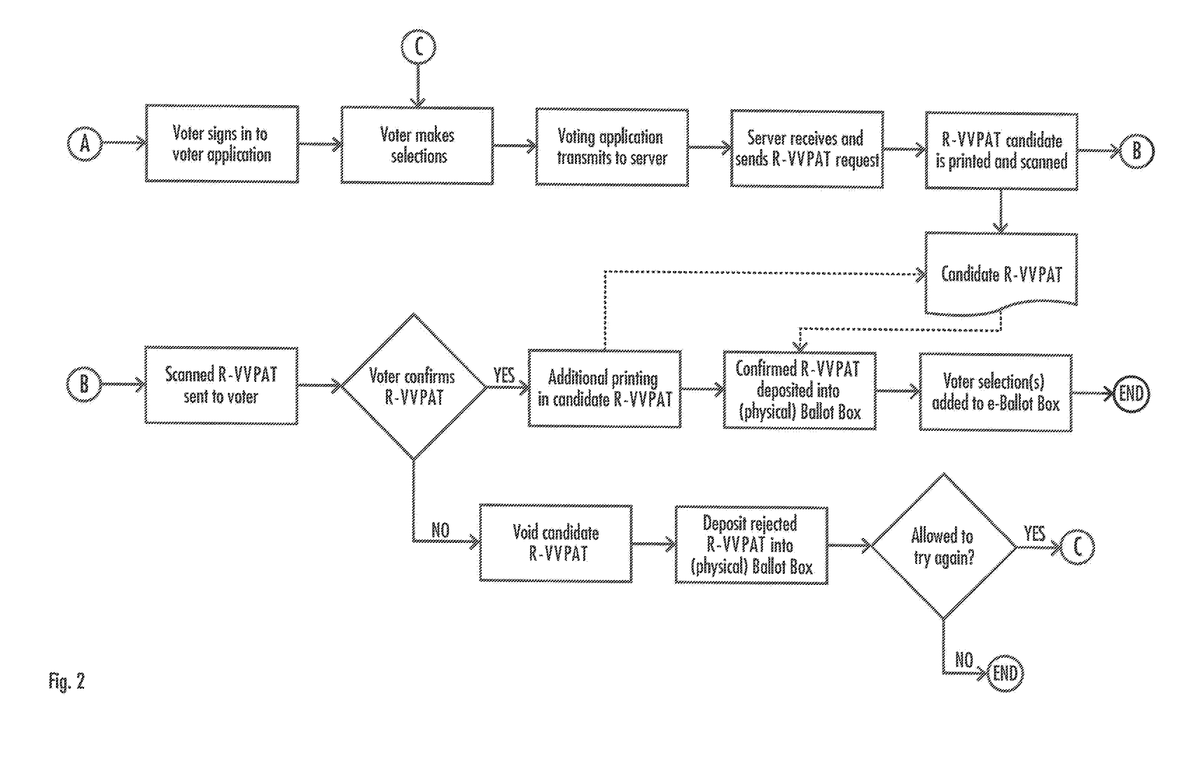

### Numerals Include:

10 Voting application
20 Server
30 E-ballot box
40 R-VVPAT device
50 Paper ballot box
110 Voter selections
115 R-VVPAT request
120 Verification image
130 Selection confirmation
140 Confirmed R-VVPAT
150 Candidate R-VVPAT
160 Printed candidate R-VVPAT image
170 Confirmed electronic ballot
180 Rejected candidate R-VVPAT

FIG. 2 shows the main steps of the process of generation of a R-VVPAT in its preferred embodiment.

### DESCRIPTION OF THE PREFERRED EMBODIMENTS

Let there be a system comprising a voting application 10, which may be a software running on a computer, smart phone, tablet PC or other type of electronic device with a user interface that can be used for voting (e.g., visual, auditory, tactile, voice-based, taste-based, or any combination of these interfaces). The voting application 10 is usable by a voter after said voter's identity has been duly authenticated using any means of authentication of a voter's identity remotely such as available in the prior art (e.g., voter-specific personal identification number, a voter's provision of personal identifiable information, voter-specific government-issued smart identity card, voter-specific government-issued information or credentials, etc.).

After authentication, voting application 10 starts a voting session or transaction, presenting to a voter candidate options from which the voter can choose his preferences according to set election rules as found in the prior art and as commonly in use in any type of elections around the world (e.g., plurinominal choice, uninominal choice, single transferable vote, straight party contests, etc., for public or private elections). After making his choices as dictated by the voting interface(s) in use, the voter can review his choices and make any modifications to them such as described in the prior art before casting his ballot.

Once ready to cast his ballot, the voter chooses to submit the ballot. The voter's selections are packaged electronically by voting application 10 into voter selections 110 and submitted by electronic means to a central processing server 20, which may be located in a geographical location different from the voter's (whether meters away or a very distant location). The central processing server server 20 receives the selections and acknowledges to the voter that the same have been received. The server 20 then proceeds to print a copy of the voter's selections centrally, by sending information found in voter selections 110 to R-VVPAT device 40 in the form of R-VVPAT request 115. The R-VVPAT request 115 is an electronic manifestation of the voter selections 110 to be transmitted to R-VVPAT device 40, and may contain any combination of (but not limited to): general election information header (indicating the election process to which the ballot relates to), the jurisdiction to which the ballot applies to, the identification information of the voter casting the ballot, the voter's choices, as well as printing layout and formatting information. Additional information that may be pertinent to the process of printing of the ballot may also be sent, such as a machine-readable image or graphic of the voter selections 110, or additional information based on the voter, the voting session or transaction, the voter's ballot, random data, or a combination of the same, that may serve for verification purposes as described below. In some implementations, any information identifying the voter's identity may be omitted from voter selections 110 to protect the voter's privacy (i.e., the principle of ballot secrecy).

The R-VVPAT device 40 takes R-VVPAT request 115 and produces a human-readable and machine readable (or only either a human-readable or machine-readable), paper-based version of the information contained in it, called a candidate R-VVPAT 150. The same may be generated as a single printed document in a single location, or as a set of printed documents produced independently of each other in multiple locations (but as a result of the reception of the voter selections 110 by the R-VVPAT device 40). In case a set of multiple printed documents are produced, each document may contain the entirety (i.e., all copies are identical) or a subset of the information contained in the voter selections 110. The printed product or products of the R-VVPAT device 40 are collectively called candidate R-VVPAT 150. The same are stored temporarily and in control of the R-VVPAT device 40 until the end of the voting session or transaction. The R-VVPAT device 40, if desirable, may operate in a way that no one, whether in physical proximity to it or not, can know what it is doing, processing or printing in relation to the voting session or transactions, but a means to monitor the operation of R-VVPAT device 40 may be provided, such as a means to monitor that it is operating correctly as desired.

Immediately after candidate R-VVPAT 150 is committed to permanent form on paper, an electronic image of the same is generated by the R-VVPAT device 40. This electronic image is called printed candidate R-VVPAT image 160 and perfectly matches and comprises the logical contents and information of the candidate R-VVPAT 150, but is found in electronic form in that it can be displayed in an electronic display in a human readable fashion (and optionally also in machine-readable fashion), in part or in whole. Accordingly printed candidate R-VVPAT image 160 is electronically returned to server 20 (and permanently stored in server 20), which then transmits the same via electronic means back to the voting application 10 or to the verification application 60 (or both). Said applications display the same printed candidate R-VVPAT image 160 to the voter to enable the voter who cast the ballot to confirm that the recorded contents of his ballot are correct and matching the ones he submitted. In case a verification application 60 is used, a voter must have gained access to it be means similar to the means used for the voter to gain access to the voting application 10.

Candidate R-VVPAT 160 can exist in one of two states of persistence:
1. ‘Ephemeral disclosure’, whereby Candidate R-VVPAT 160 is deleted from the voting application 10 or verification application 60 immediately after being confirmed as a ‘valid’ faithful representation of the voters original voter selection, or after being deemed ‘void’ (unrepresentative of the voters selection).
2. ‘Persistent disclosure’, whereby Candidate R-VVPAT 160 remains on the voting application 10 or verification application 60 after being confirmed as valid or rejected as void.

When the printed candidate R-VVPAT image 160 is shown to the voter, if the voter agrees with the image shown he can confirm that the same matches his selections by using the voting application 10 or the verification application 60. Such confirmation is sent as an electronic message to server 20, as a result of which server 20 may optionally make R-VVPAT device 40 print additional information on candidate R-VVPAT 150 stating (in human-readable form, and optionally also in machine-readable form) that said candidate R-VVPAT 150 resulting from the current transaction has been confirmed by the voter and is thus a final voted ballot. After such final optional marking, candidate R-VVPAT 150 becomes confirmed R-VVPAT 140, and is deposited into paper ballot box 50, a secure box which content cannot be accessed or modified without authorization and without leaving evidence (i.e., tamper-evident), with the purpose of safely storing the confirmed R-VVPAT 140 documents for later use. In case the candidate R-VVPAT 150 consisted of more than one printed document, confirmed R-VVPAT 140 also consists of the same number of documents, all of which are marked by R-VVPAT device 40 accordingly and deposited in one or more paper ballot boxes 50.

As a result of the confirmed R-VVPAT 140 being deposited in paper ballot box 50, a new electronic document called confirmed electronic ballot 170 is also created based on the original electronic copy of R-VVPAT request 115, and is permanently stored in electronic form in e-ballot box 30. E-ballot box 30 is a medium of storage of electronic documents and data. Confirmed electronic ballot 170 contains at least all the information found in confirmed R-VVPAT 140 (i.e., it is a logical identical copy of confirmed R-VVPAT 140), and may contain additional information to guarantee its safety and prevent it from being modified by unauthorized means or people (e.g., the electronic document may be digitally signed, encrypted or otherwise recorded in a tamper-evident or tamper-proof electronic means). In the preferred embodiment confirmed electronic ballot 170 is the official ballot that will be used for election tally purposes, while confirmed R-VVPAT 140 paper document will be used for recount or audit purposes, but a different approach may be followed (such as using the paper document for a hand count and produce final election tally, and using the electronic copy as back-up).

If the voter does not agree with printed candidate R-VVPAT image 160 shown to him for confirmation (e.g., because he considers the information contained therein doesn't match his selections, or he has changed his mind, etc), the voter can choose not to confirm the transaction using voting application 10 (and/or verification application 60), in which case, a message is sent electronically to server 20. Server 20 then optionally marks candidate R-VVPAT 150 as void or not valid, by printing additional information on it stating (in both human-readable and/or machine-readable forms) that said candidate R-VVPAT 150 resulting from the current transaction has not been confirmed by the voter. When such printing is done, candidate R-VVPAT 150 becomes rejected candidate R-VVPAT 180. Rejected candidate R-VVPAT 180 is then deposited into said paper ballot box 50, with the purpose of safely storing the rejected candidate R-VVPAT 180 documents for later use. A digital record of such rejection is stored by permanent means in server 20.

In this case of a voter not agreeing with printed candidate R-VVPAT image 160 shown, the next step may be one of many options, all of which can be made available or not to voters as desired. First, the voter may be given another opportunity to vote (which would take him again from the beginning of the transaction, starting with the initial interaction of the voter application 10 above). This could be repeated one or more times, as desired, until the voter decides to accept the selections shown in the digital R-VVPAT shown to him. Second, the voter can be told at once (of after repeating the process N>=1 times without confirming the printed candidate R-VVPAT image 160) that he will have to go to a physical precinct to vote in person as a result of his not confirming the selections shown in the printed candidate R-VVPAT image 160.

The above process is summarized in FIG. 2, showing the main steps of the entire process. The described process is the preferred embodiment. Nonetheless, additional functions may also be part of the embodiment of the disclosure. Many of the same are listed next.

A voting application 10 and a verification application 60 are mentioned above. These may be software application or devices owned by or made available to the voter for voting and verification. The voting application may support both the act of voting and verification, whereas the verification application may only serve the purpose of voting. Both applications may operate on the same device, but preferably they may operate in independent devices, e.g., the voting application may be an Internet browser-application or stand-alone application for voting on a personal computer, while the verification application may operate on a separate smart phone or other mobile device application. The simplest embodiment is when the voting and verification functions reside within the same application made available to the voter on any device.

In the above preferred embodiment the voter is always given the possibility to confirm that his ballot has been recorded accurately. Nonetheless, voters may be given the choice whether or not they want to confirm their ballot has been recorded properly. In case they choose not to confirm said record, the confirmed R-VVPAT 140 may still be produced, but without having to revert back to the voter for confirmation (i.e., the voter implicitly or explicitly has validated the R-VVPAT by choosing not to expressly confirm his selections have been recorded properly). While many voters may choose explicitly they want to confirm their vote has been recorded properly, other voters may not think this step is absolutely necessary (e.g., they trust the system to record their vote properly both electronically and on paper).

In the preferred embodiment the voting application 10, verification application 60, printed candidate R-VVPAT image 160, and all other interfaces that come in contact with the voter (and all other interfaces) are created in a primary language (i.e., the primary or official language used in the electoral jurisdiction). But in some cases, a secondary or even a number of additional languages or scripts may be supported. In such case any such interfaces as mentioned above may be stored, displayed and printed in the primary language as well as any additional languages that may be desired. The information to be stored, displayed or printed in multiple languages may be the entire information used in such components or interfaces, or only a subset of the information as deemed appropriate.

In the preferred embodiment, the printed candidate R-VVPAT image 160 and candidate R-VVPAT 150 contain the same exact information in two different formats (printed document and electronic document, respectively). Other embodiments are possible, including (but not limited to): the candidate R-VVPAT 150 may have two different sections, one showing the voter selections (i.e., selection section) and another showing information relevant for the voter to confirm that his ballot has been received, but without showing the voter his selections in clear text (i.e., verification section). In this case, only the verification section is packaged as the printed candidate R-VVPAT image 160 and sent back to the voter for verification (i.e., the selection section is omitted from the printed candidate R-VVPAT image 160). In this case, the voter need not confirm again his choices, but can keep a copy of the printed candidate R-VVPAT image 160 to later use the information contained therein to verify his ballot has been recorded as desired. In this embodiment, the contents of the e-ballot box 30 and of the paper ballot box 50 would be made public at any future time (including possibly all stored copies of complete printed candidate R-VVPAT images 160, if deemed necessary), as in of straightforward consultation by a general audience such as a web-based bulletin board. Voters could then use the information they received in the form of verification section of the printed candidate R-VVPAT image 160 during their voting session or transaction to check that their ballot indeed was received, and the contents did match their intended selections, and that the same match with the records of printed candidate R-VVPAT images 160 and confirmed R-VVPAT 140.

In the preferred embodiment, the printed candidate R-VVPAT image 160 is sent back to the voter in the form of a still image in electronic format (which may be digitally signed or packaged in a way as to be possible for the voter to validate it originates from a legitimate source). The same may contain an identification number uniquely identifying the voter's current voting session or transaction (e.g., by showing the voter's IP address, MAC address, IMEI number or other such number uniquely identifying the interface or session the voter is using to vote), and displayed in a way that the voter can understand. Other embodiments are possible, including (but not limited to): the printed candidate R-VVPAT image 160 sent back to the voter may be in the form of a secure live video feed (e.g., video stream) that is only available to said voter during said voting session or transaction. Said live video feed is automatically stopped when the voter confirms his selections have been recorded properly, and may not mean that a proper printed candidate R-VVPAT image 160 in the form of a still digital image is not stored at the same time.

In the preferred embodiment, the printed candidate R-VVPAT image 160 is sent to the voter in a way that is identical to what has been printed by R-VVPAT device 40. Other embodiments are possible, including (but not limited to): a printed candidate R-VVPAT image 160 being overlaid with additional visible, human-readable information not found in the original candidate R-VVPAT 150 to which it corresponds, which information may have been left out of the candidate R-VVPAT 150 for any reason, e.g., to preserve a voter's privacy. For instance, the candidate R-VVPAT 150 may not contain information related to a voter's identity (such as voter id number, name, IP address, etc.), but said information may be overlaid over the digital image of printed candidate R-VVPAT image 160 sent to the voter, when deemed that this information may be essential to a voter's confirmation of the ballot. In a similar fashion, information contained in candidate R-VVPAT 150 may be deemed not necessary for a voter's confirmation of his selection and may therefore be omitted from the printed candidate R-VVPAT image 160 sent to the voter. In the preferred embodiment the printed candidate R-VVPAT image 160 and candidate R-VVPAT 150 are identical, but they may be displayed in modified means as just described in other embodiments for any reason considered valid (e.g., to preserve a voter's privacy, to increase convenience, etc). All such modifications ideally would be pointed out and clearly identified to voters' during voting to avoid confusion.

In the preferred embodiment, the printed candidate R-VVPAT image 160 is a human-readable image that can be displayed in any type of electronic display. Other embodiments are possible, including (but not limited to): the printed candidate R-VVPAT image 160 being in a machine readable format that is interpreted and converted to human-readable format by the voting application 10 or verification application 60; the printed candidate R-VVPAT image 160 may be broken into separate components and each sent to a specific application as requested by the voter, or desired by electoral authorities.

In the preferred embodiment all of the above steps are carried out in a transactional manner. This means that from the step in which the voter authentication in voting application 10 (and the voting session or transaction starts) until confirmed R-VVPAT 140 is deposited into paper ballot box 50 and the confirmed electronic ballot 170 has been stored in e-ballot box 30, in case anything happens that prevents the full process to be completed, said voting session or transaction is declared void or failed, and all partial steps can be undone (or rolled back), including: any partially or fully produced printed candidate R-VVPAT image 160, candidate R-VVPAT 150, or other documents in printed or electronic form can be voided and marked (physically or logically) as belonging to a failed voting session or transaction. This also includes the voter being notified of such failed voting session or transaction, and asked to restart the process, if considered necessary and within the desired operation of the system by the authorities. The transactional nature of the system implies that the communication and information exchange between any components is also of a transactional nature.

In the preferred embodiment the voter confirms his selections and confirmed R-VVPAT 140 and confirmed electronic ballot 170 are created as described above. Other embodiments are possible, including (but not limited to): a partial or full copy of the confirmed electronic ballot 170 and/or confirmed R-VVPAT 140 is sent to the voter after completion of the voter session or transaction via a different means, possibly even hours, days or weeks after such completion, via a means such as email, SMS, regular mail, etc. Said copy may include any or all information contained in said documents.

In the preferred embodiment all actions of the system (including actions carried out on or by any of the system components), particularly those related to a voter's voting session or transaction, are continuously being registered in an electronic log in server 20. Other embodiments are possible, including (but not limited to): a partial or full copy of the log listing and describing such transactions being produced by a means similar to the R-VVPAT device 40 in permanent printed form.

In the preferred embodiment the R-VVPAT device 40 is a device that serves as an accessory or peripheral to server 20, and can process multiple, concurrent voting sessions or transactions carried out by multiple voters. Its throughput can be planned in proportion to the maximum expected number of concurrent voters, so that all such voters can be served without negatively impacting or generating undue delays in the voters' experience while voting. This means that R-VVPAT device 40 may comprise multiple processing units, multiple printers, multiple scanners, multiple electronic transmission means, and multiple electronic storage means. The R-VVPAT device 40 may in addition have one or multiple paper ballot box 50 attached to it to store all types of printed documents that the device produces. Other embodiments are possible, including (but not limited to): a single processing unit may fulfill the functions of server 20, R-VVPAT device 40, and paper ballot boxed 50, having the capability to support multiple (hundreds or thousands) of concurrent voting sessions or transactions concurrently. In the preferred embodiment, the system would be able to support concurrent peaks of 100 voting sessions per minute and up to 10 voting sessions per second in a voter population of 180,000 voters voting over a 7 day period for a national-level election. Other embodiments may require different throughputs.

In the preferred embodiment the voter gets to go through the entire voting process to generation of an R-VVPAT only once, and such result is deemed to be his valid cast ballot. Other embodiments may be possible, following specific implementation or regulatory requirements, such as including a voter given the possibility to cast his ballot multiple times. This can be done to help prevent voter coercion (whereby a voter is forced to vote in a specific way while under external influence). In such other embodiments the voter could be allowed to use voting application 10 more than once (each time resulting in a confirmed electronic ballot 170, as per the process described above), and only one of his cast ballots would be counted in the election result, which may be the first ballot cast, the last ballot cast, or any of the multiple ballots cast. In such case, as multiple instances of confirmed electronic ballot 170 and confirmed R-VVPAT 140 may be produced, a logical electronic record must be kept in server 20 as to which is the ballot cast by the voter that must be considered valid (since all confirmed R-VVPAT 140 will already be inside paper ballot box 50 and it may not be possible to physically mark them further after they have been deposited.

In the preferred embodiment paper is used as medium to print the printed candidate R-VVPAT 160 and confirmed R-VVPAT. Further, other physical media are also suitable, including plastic, teslin fabric, stone, glass, or other such suitable material (whether of natural occurrence or man-made) that can be used to produce a physical image visible to the human eye.

Thus, the reader will see that the present embodiment of the disclosure to implement a remote voter-verifiable paper audit trail improves on the state of the art by introducing a novel means to verify remote electronic elections. While our above description contains many specificities, these should not be construed as limitations to the scope of the embodiment of the disclosure, but rather as exemplifications of one or more preferred embodiments thereof. Obviously, modifications and alterations will occur to others upon a reading and understanding of this specification. The description above is intended, however, to include all such modifications and alterations insofar as they come within the scope of the appended claims or the equivalents thereof.

### ADVANTAGES OF THE EMBODIMENT OF THE DISCLOSURE

The present disclosure tackles the need of verifiability in remote electronic elections by proposing a means by which paper trails can be generated in a way to both satisfy a voter's need to verify the ballot he submitted over electronic means (e.g., the Internet) has been recorded properly (and his selections are faithfully recorded), and the need of electoral officials to be able to demonstrate to stakeholders that the result of an election (including the ballots cast from remote locations) can be recounted to verify the election, such as done by hand counting the confirmed R-VVPAT 140 contained in all the paper ballot boxes 50.

The present embodiment of the disclosure addresses the need in certain jurisdictions where tabulation must be performed on paper ballots rather than directly on the electronic record of the vote (e.g., New South Wales 2011) as defined by electoral law.

1. A remote voting system, comprising:
a voting device by which a voter can electronically cast a ballot containing voter selections from a remote location; and
at least one device at a physical location different than the remote location and by which a physical copy containing the voter selections can be printed or otherwise produced.

2. The system of claim 1, wherein:
the at least one device acquires and electronically sends to a display a digitalized version of the voter selections contained in the physical copy,
the display displays the digitalized version, and
the voter can validate or reject by way of a validation device that the voter selections have been recorded properly on the physical copy.

3. The system of claim 2, wherein when the voter validates the voter selections, and thus confirms that the voter selections in the digitalized version match those contained in the cast ballot, (i) a final printed copy containing the validated voter selections is marked by the at least one device as valid by printing additional relevant validation information on the final printed copy, and (ii) the final printed copy is deposited in an attached ballot box.

4. The system of claim 2, wherein when the voter rejects the voter selections in the digitalized version, the physical copy is then (i) marked by the at least one device as not valid and (ii) deposited in an attached ballot box.

5. The system of claim 3, further comprising, at a physical location different than the remote location, a non-transitory computer-readable storage medium that stores an electronic ballot box, wherein:
simultaneously with the final printed copy being deposited in the attached ballot box, the voter selections are committed to permanent storage in electronic form in the electronic ballot box,
the voter selections of the electronic form match exactly the voter selections validated by the voter, and
the voter selections of the electronic form match exactly the voter selections of the final printed copy deposited in the attached ballot box.

6. The system of claim 4, wherein upon a voter's rejection of the voter selections, the voting device gives the voter another opportunity to make voter selections and cast a ballot.

7. The system of claim 4, wherein the ballot box in which the invalidated physical copy is deposited is protected from unauthorized access by a physical device configured to prevent anybody from reading the voter selections of the invalidated physical copy until a duly authorized opening of the ballot box takes place.

8. The system of claim 5, wherein the voter selections contained in the physical copy are identical to those of the digitalized version, the final printed copy, and the electronic form.

9. The system of claim 5, wherein additional information beyond the voter selections is included in at least one of the physical copy and the digitalized version, the additional information being clearly identified as being additional to the voter selections.

10. The system of claim 5, wherein additional information beyond the voter selections is included in the electronic form, the additional information being clearly identified as being additional to the voter selections.

11. The system of claim 1, wherein the voter selections contained in the physical copy are in a human-readable format, a machine-readable format, or both the human-readable and the machine-readable formats.

12. The system of claim 2, wherein the voter selections contained in the digitalized version are in either a human-readable format, a machine-readable format, or both the human-readable and the machine-readable formats.

13. The system of claim 5, wherein the final printed copy containing the validated voter selections is either the physical copy or a different printed document including both the voter selections and additional information considered relevant to an election process.

14. The system of claim 1, wherein:
the physical copy containing the voter selections is a single piece of paper that is printed in a single geographical location by a single one of the at least one device, or
the physical copy is a plurality of different documents satisfying at least one of the following: each of the different documents contains a relevant part of the voter selections, each of the different documents is printed on a different piece of paper, and each of the different documents is printed in a different geographical location.

15. The system of claim 3, wherein:
the final printed copy is a single piece of paper printed in a single geographical location different than the remote location by a single one of the at least one device, or
the final printed copy is a plurality of different documents satisfying at least one of the following: each of the different documents contains a relevant part of the voter selections, each of the different documents is printed on a different piece of paper, and each of the different documents is printed in a different geographical location.

16. The system of claim 1, wherein the physical copy contains relevant pre-printed information that is not related to any possible voter selections but that serves to differentiate between properly printed voter selections and voter selections produced by a different, unauthorized system.

17. The system of claim 5, wherein the voting device, the display, and the validation device are the same.

18. The system of claim 5, wherein the voting device, the display, and the validation device are separate.

19. The system of claim 5, wherein:
the validation device gives the voter a choice of whether the voter wishes to validate that the voter selections have been recorded properly on the physical copy, and
if the voter chooses not to validate the voter selections, the final printed copy is produced and deposited in the attached ballot box without further validation by the voter.

20. The system of claim 5, wherein all interaction with the voter by the voting device, the display, and the validation device is performed in one or more languages or language scripts of the voter's choice.

21. The system of claim 5, wherein the digitalized version contains a subset of information found in the physical copy sufficient for the voter to verify that the voter selections have been received but insufficient to show the voter the voter selections that have been received and recorded.

22. The system of claim 5, wherein the digitalized version displayed by the display is digitally signed or otherwise protected and packaged in a way to enable the voter to distinguish that the voter selections of the digitalized version are a product of the voter's casting the ballot.

23. The system of claim 5, wherein the digitalized version displayed by the display is a digital still picture of the physical copy.

24. The system of claim 5, wherein the digitalized version displayed by the display is a secure live video feed of the physical copy.

25. The system of claim 5, wherein additional information in at least one of machine-readable and human-readable formats is overlaid or otherwise added to the digitalized version displayed by the display, the additional information being clearly identified as additional to the voter selections.

26. The system of claim 5, wherein only a subset of information contained in the digitalized version is shown to the voter by the display for validation, omitted information from the digitalized version being clearly identified as such to the voter.

27. The system of claim 5, wherein failure of any said action performed by the voting device, the at least one device, the display, the validation device, or the electronic ballot box causes the display to notify the voter of the failure.

28. The system of claim 5, wherein an additional final printed copy of at least part of the voter selections is produced and physically or electronically sent to the voter.

29. The system of claim 5, wherein the voter is given by the voting device the opportunity to successfully cast a ballot multiple times, only one of which will result in a valid cast ballot.

30. A voting device, comprising:
a memory;
a display; and
a processor specifically configured to:
receive electronically a ballot containing voter selections of a voter;
transmit the voter selections to a location remote from the voting device;
receive from the remote location a digitalized version of a physical copy containing the voter selections;
display on the display the digitalized version;
allow the voter to validate or reject that the voter selections have been recorded properly on the physical copy; and
transmit the result of the validation to the remote location.

31. A device, comprising:
a memory; and
a processor specifically configured to:
receive voter selections contained in a ballot electronically cast by a voter at a remote location;
control a device to print a physical copy containing the voter selections;
send to the remote location a digitalized version of the voter selections contained in the physical copy for validation by the voter; and
if the voter validates that the voter selections have been recorded properly on the physical copy, cause (i) a final printed copy containing the validated voter selections to be marked as valid and (ii) the final printed copy to be deposited in an attached ballot box.
